(19) United States
(12) Patent Application Publication
(10) Pub. No.: US 2008/0230239 A1
(43) Pub. Date: Sep. 25, 2008

(54) Structural Arrangement Which Assists Rapid Fire Load Combustion and Smoke and Gas Evacuation

(75) Inventor: Salvador Mateu Climent, Valencia (ES)

Correspondence Address: EGBERT LAW OFFICES, 412 MAIN STREET, 7TH FLOOR, HOUSTON, TX, 77002, US

(73) Assignee: THERTIM, S.L., Valencia (ES)

(21) Appl. No.: 10/597,891

(22) PCT Filed: Feb. 10, 2004
(86) PCT No.: PCT/ES2004/000056

§ 371 Date: Apr. 18, 2008

(30) Foreign Application Priority Data
Feb. 11, 2003 (ES) P 200300332

(51) Int. Cl. A62C 3/00; F23J 11/00

(52) U.S. Cl. 169/54; 454/1

(57) ABSTRACT

The invention relates to an arrangement for the rapid combustion of the fire load within reach of a fire and of the hot gases and smoke produced by the fire. The invention involves installing an external sheet and an internal sheet of reinforced concrete along the perimeter of, or at points along, the partitions, walls or facing of a building. The sheets are separated by an air chamber acting as a chimney. According to the invention, a chimney is connected to the chamber and to an inlet. The chimney also includes an outlet which is connected to the shaft or central duct thereof. The invention also includes an independent air chamber which is disposed in the external sheet external to the façade.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The following description refers to an application for the patent of an invention, regarding a device for the rapid consumption of the combustible load found within reach of a fire, in addition to the smoke and hot gases produced by the fire. The purpose of the invention is based on the fact that it takes advantage of the ventilated chamber in a double-sheeted façade to build a chimney, using the draft produced by the difference in pressure to cancel, reduce, and even put out the fire.

It must be pointed out that all materials used have a predetermined resistance to fire.

This invention finds its application in the field of industry devoted to any type of construction work, even ship builders.

### BACKGROUND OF THE INVENTION

Depending on the gases and heat interchangers with the surroundings, all fires can be divided into two groups:

Fires in open spaces, that is to say at the mercy of the elements; and

Fires in covered enclosures.

If the speed at which a fire spreads and the speed of the air influx are also taken into account, additional subgroups can be made.

There can be three types of fire in open spaces:

Localized fires.

Developing fires.

Full-blown fires.

There are two types of fire in covered enclosures:

Fires in open covered enclosures.

Fires in closed covered enclosures.

The invention under study will only deal with fires produced in covered enclosures.

Generally speaking, a fire in a combustible environment will spread and grow until it has used up all the combustible available or has been put out.

As regards fires in open covered enclosures, it must be pointed out that these fires can occur in large confined spaces (with high ceilings and large openings), with a large amount of air available, which makes this type of fire similar to those produced in the open air.

Fires in open covered enclosures are characterized by their high speed of combustion, but they are not very destructive.

The physical-chemical characteristics of the combustibles, volume, and spatial layout in the enclosure, all control the duration of the fire, and usually the flames emerge from openings and spread to combustibles that are found outside.

As far as fires in closed covered areas are concerned, it must be pointed out that in rooms or other areas with small openings (or without windows or doors), and in the absence of forced air streams, they are limited to the interaction between the air and gases.

These conditions are found on ground floors of buildings, in garages, discotheques, etc. and, therefore, fires in this kind of environment are controlled by ventilation. They burn for less time and can be very destructive due to the high temperatures reached during the development period.

The speed of combustion does not depend so much on the fire load than on the speed of the air influx. The abundance of smoke and toxic gases generated during combustion make this kind of fire very dangerous for human beings.

It must be pointed out that, regarding the ignition and spreading of a fire, the fire starts when a strong ignition force comes into contact with (or is in close proximity to) a combustible or inflammable material for long enough to reach self-maintained combustion.

This description will deal with the combustion of solid materials, but the principles are valid for the combustion of liquids and gases, since in almost all cases the basis of combustion is the formation of combustible vapors of the material and their reaction with an oxidant.

In the case of liquids and gases, there are vapors even at an ordinary temperature. Therefore, generally speaking, it is easier for liquids and gases to set on fire than solids.

The prolonged heating of the surface of the material leads to a series of complex chemical reactions, called pyrolysis, which decompose the material into volatile compounds with a lower molecular weight and a solid waste product (carbon in the case of cellulose material). This process does not necessarily require the presence of oxygen in the air, as pyrolysis can increase if heating is rapid and the ignition source strong.

Thin materials cannot dissipate the heat they receive rapidly, and therefore become hotter more quickly. On the other hand, thick materials (especially those that are good conductors) transmit heat from the surface towards the inside, preventing the surface from heating up rapidly, and the fire spreads more slowly.

Once a fire has ignited and started to spread, its subsequent progress and effects on people and property will depend to a large extent if it is in the open air or inside a closed area.

The influence of the spatial orientation of the material is common knowledge and a fire spreads extremely quickly along vertical surfaces, as thermal transference by convection considerably increases the area heated and the flames directly touch the surface. On the other hand, a fire usually spreads slowly in a horizontal direction as heat dissipates rapidly by convection and the adjacent surface is only heated by the heat from the flames or the materials or objects heated in the vicinity, or by thermal conduction if the material is thick.

Fires in closed covered areas have been closely studied in both theory and with practical experiments, and nearly all research studies fires in homes, as these covered enclosures are more dangerous for people if a fire breaks out. Although progress has been made, there are still gaps in our knowledge on the dynamics of fires in closed covered areas.

From a safety point of view regarding human life, fires in closed covered areas can be divided into two periods.

The first period is related to the ignition and spreading of the fire on individual objects within the enclosed area: the period previous to the inflammation point. The second period corresponds to the rapid ignition and combustion of all the combustible material available (inflammation point) and the subsequent spreading of the fire outside the enclosed area (the period following the inflammation point).

The first period is important for the safety of people within the enclosed area, while during the second period people in other parts of the area are under threat and the whole building is in danger.

During the initial stage of a fire in an enclosed area, the growth and spreading of the fire are similar to those in the open air. However, the subsequent development and direction of the fire depends on several factors, the most important being, amongst others, the total amount of combustible material found within the area (including wall coverings) as well as the speed of heat radiation of the material that first set alight, and the general geometric and thermal characteristics of the boundaries of the enclosed area.

Covered enclosures with lots of furniture and combustible wall coverings cause a fire to spread quicker than covered enclosures with little furniture and walls covered in non-combustible material. Once the fire has set alight within the area, hot combustion products are given off that mix with the surrounding air, floating like a feather up towards the ceiling. As the gases and smoke accumulate at the ceiling, a significant difference in pressure comes about and two different layers appear.

The upper layer, which is the hottest, increases in size until it finally finds a way out (usually the upper part of a window or open door), and as the combustion of the element that first set alight intensifies, the temperature of the hot layer rises, increasing the temperature of the ceiling and walls. The walls irradiate thermal energy to the rest of the combustible materials on the floor and the lower part of the enclosure that have not yet set alight. It must be pointed out that heating by radiation of the flames of the combustibles, and by conduction along the floor, is not very intense.

The combustible ceiling and walls increase the thermal flow that reaches the floor. This means that the fire can spread more quickly along the ground if the ceiling and walls are covered in a combustible material.

In covered enclosures with little furniture, the element that first set fire may burn without setting other combustibles alight. However, in areas with a lot of furniture (the living room and bedrooms in a home, for example), a fire will probably spread more easily, and the entire enclosed area will set alight.

The combustibles on the floor and lower levels that have not yet set on fire get hotter and hotter due to the radiant heat given off by the ceiling and upper layer. In a given moment, almost the entire enclosed area reaches its temperature of ignition, exceeds it, and the fire quickly spreads throughout the entire enclosed area.

This transition of localized fire to total fire involving the entire enclosed area is called the “inflammation point”.

As regards the period following the ignition point, it must be pointed out that the period following the inflammation point of a fire in an enclosed area is called a “full-blown fire”. This is when all the important parameters of a fire (such as temperature, heat generation, speed of combustion, production of smoke, flame height, etc.) reach their peak.

Based on the results of research on fires in covered enclosures carried out during the 1920s, it was thought that the nature of a full-blown fire was determined mainly by the amount of combustible found in an enclosed area. In other words, the meaning and role of a single reactive (the combustible) was recognized in the basic reaction of a fire. Consequently, it was universally accepted (even up until the present day) and was the basis for protection against fires in enclosed areas in the use of non-combustible boundaries.

By means of fire tests in covered enclosures, a deeper depression was obtained in the period following the inflammation point, and one characteristic of these tests and studies is that almost all of them refer to ordinary cellulose materials, although it was unknown whether the results obtained would be applicable to other solid combustibles such as plastics or some metals. Another important characteristic is the complexity of the studies and experimental tests, and the limited repeatability inherent to incendiary processes, since several researchers later solved the problems by using techniques and models.

Despite these inconveniences, unquestionable conclusions have been reached, and perhaps the most important thing is that the nature of a full-blown fire depends to a large extent on the second reactive in the fire equation: the amount of air present and the influx of air into the enclosed area, in addition to the amount of combustible involved in the fire. This has made it possible to predict important fire variables with sufficient accuracy, such as the speed of combustion, the temperature within the enclosed area, the speed of heat generation, and the length of a fire.

Regarding the dynamics of the behavior of a fully developed fire, it must be pointed out that most people have never seen a hostile fire and cannot imagine how quickly a fire can develop. Neither are they familiar with the phenomenon known as a “flash over”, and waste valuable time confirming there is a fire or gathering up their belongings. They also try to leave by the usual exits. The only way to guarantee that people behave correctly and safely during a fire is to practice this type of behavior.

The behavior to scale of these dangerous fires is of top priority in research. Over the past few years, scientists have developed new laboratory tests that can facilitate data relevant to the development of fires on a large scale. They have even prepared complicated computer programs capable of predicting the behavior of a fire from the beginning of ignition, through the different stages of growth, up to a full-blown fire in a room (flash over), and the spreading of a fire to adjoining rooms and possibly to other buildings.

Once the transition from “flash over” to “active participation” has begun in the room, the fire approaches control by ventilation and frequently the smoke below the neutral plane circulates back towards the fire, together with the smoke that may have accumulated in adjacent compartments in the hall. This process reduces the amount of oxygen available for combustion, causing reduced heat emission indexes or causing the fire to approach a state of constant combustion.

Under certain circumstances, the location of a fire in a room can have an effect on the rate of development of the fire as far as the speed of the air temperature at the ceiling is concerned. When a fire burns in a room away from the walls, the air is free to enter the plume of smoke from any position.

If the fire is near a wall or corner, the amount of air that enters the plume of smoke is reduced, and the heat release index can be adjusted in the correlations used to calculate temperature and speed. It must be taken into account that, nevertheless, experimental tests have shown that in a circular burner, situated in such a way that it comes into contact with the wall at only one point, the fire behaves identically to when it is at a distance from the wall.

The aim of the aforementioned description is to give a general perspective of the process involved in the development of a fire and how it spreads within and beyond the compartment.

Death rates may increase if the size of the room is smaller, and for this reason the conditions associated with the “flash over” in the room where a fire starts may occur earlier than in the rest of the house. People living in prefabricated houses are usually poorer than those living in other types of homes (and especially those living in old subsidized housing), and it must be taken into account that poverty is associated with higher death rates caused by fires.

The NFPA 780 does not specify a maximum level of recommended resistance, while the British Standard Code of Practice 1 recommends a maximum resistance of 10 ohms for a lightning protection system that usually includes two or more electrodes in the ground.

10 ohms is also generally considered a reasonably good earth resistance for transmission towers, and in this case a high resistance to the ground could result in a “flash over” in the line of conductors, although the aerial earth cable intercepts the direct overload from lightning.

The department of agriculture in the United States recommends an earth resistance not greater than 50 ohms for the protection of structures on farms.

The arc components of electric engines must be protected by “flash over” screens, firebreaks, vents or ventilation, if inflammable liquids or gases are pumped or compressed.

Ventilation is very important when fighting fires, as it means the smoke, gases and heat are eliminated from a building. Ventilation in buildings has the following important functions:

It protects life by eliminating or deflecting toxic gases and smoke in places where the occupants of a building may seek temporary shelter.

It makes the state of the area surrounding the fire better by eliminating smoke and heat.

It controls the way in which a fire spreads by establishing air streams that cause the fire to move in a required direction, as in this way the occupants and valuable objects can be protected more quickly.

It releases combustible gases without burning before developing an inflammable mixture, and therefore avoiding a “backdraft” or smoke explosion.

The designer of the building must be aware of these important functions of the ventilation of fire, and provide effective measures to make it easier to ventilate the building in the form of access panels, moveable windows, skylights, or other ways of easily opening up an enclosed area in the case of an emergency. Emergency controls on mechanic equipment, including engineering systems to control smoke, can also be a very effective way to ventilate a fire. It must be pointed out that each building has its own characteristics, and therefore one single solution must be incorporated into the design of each one.

As regards the chimney, it must be pointed out that it is a conduct along which smoke and gases (which come from combustion or industrial operations, and which may have a load of solid or liquid particles or not) are emitted into the atmosphere.

In principle, a chimney is made up of a vertical tube (called shaft or flue), the section and height of which make it possible to obtain a large enough flow to emit all the smoke and gases into the atmosphere, and guarantees the draft required for hearths and burners to operate correctly (with or without the co-operation of other organs), especially for renovating comburent air.

Generally speaking, industrial chimneys are cylindrical in shape, while chimneys that are incorporated, fitted, or built in buildings used for homes or other types of property, are rectangular or square.

The emitted products disperse more easily through the higher levels of the atmosphere, and this depends mainly on the height of the chimney. It also depends on the evacuation speed and upward force of the gases, as they are lighter than air. On leaving the chimney, the vertical course of the flow of gases or the plume of smoke, changes to a horizontal course that is guided by the direction of the wind. This new course is influenced greatly by the fluctuations and eddies of the wind.

Gases also tend to spread around the chimney throat, and the particles and micro-drops in suspension are dragged by the speed of the gases. Gravity guides them progressively towards the ground, where they settle further away from their point of origin. The least dense particles and micro-drops may stay in suspension in the atmosphere to form part of the clouds. It must be pointed out that the dispersion surface increases with the square of the height, and the thickness of the deposits increases with the inverse of the aforementioned square.

In general terms, the draft of a chimney can be defined as the difference in pressure between the entrance and exit of a conduct, through which gases must circulate (in particular air and combustion gases), which is called the natural draft. This natural draft is due to the difference in density between the hot gases that circulate through the chimney and the outside air, because in order to make the air and gases circulate inside the interior circuit of the chimney, the pressure must be higher at the exit than that found at the entrance of the chimney.

With a natural draft the air enters at atmospheric pressure. It is essential to create a depression at the base of the chimney in relation to the atmosphere at this same level. The pressure of the chimney draft is known as first approximation. A chimney provides a draft proportional to the product of its height by the difference of density between the outside air and hot gases.

From the moment in which these gases circulate through the chimney, the draft is reduced by a value equal to the difference in pressure required to compensate for losses due to friction or rubbing with the walls of the chimney, and the speed of the smoke is measured as it leaves the chimney, making it necessary to increase the height of the chimney for a determined section and flow.

In short, the real air and gas flows correspond to a balance between the loss in pressure in the circuit coming from the chimney and the effective draft. In order to regulate combustion, this balance is adjusted by manipulating a manhole that acts on the admission of burning air.

The draft of short chimneys is sensitive to the action of winds on the mouth of the chimney, and adjustable cowls or “static suction” that use the depression produced by the circulation of the wind, are fitted to remedy this. It must be pointed out that their main advantage is that they cancel out the effects of descending winds.

The different types of chimney drafts are the following:

Forced draft;

Aspired draft;

Balanced draft;

Induced draft;

Mechanical draft;

Mixed draft; and

Blown draft.

A forced draft is used when the chimney cannot be built as high as required (in the case of steam locomotives, for example), or when the circuit is quite resistant to the circulation of gases, which occurs mainly in electrical plant boilers. There are several types of forced draft (aspired, induced, blown or mixed) and at present it is subjected to the burner or pressure boiler, which requires airtight walls and avoids the aspiration of smoke in a descending vertical direction.

More specifically, a forced draft is due to a mechanical action arising from an air vent or dragged by a vapor jet.

The aspired draft is a draft forced by the action of an air vent or booster placed at the exit of the circuit that uses the gases.

The balanced draft is a mixed draft in which the entrance of air and aspiration combine to maintain the atmospheric pressure around the hearth.

The induced draft is a forced draft in which part of the gas flow is aspired by an air vent and driven towards a convergent nozzle placed at the base of the chimney, where it acquires a high speed and drags the flow along.

The mechanical draft is also a forced draft that uses one or several air vents.

The mixed draft is a forced draft where air is boosted at the entrance of the hearth at the same time as smoke is aspired at the base of the chimney.

The blown draft is a draft forced by the effect of an air vent placed before the hearth.

In industrial installations (such as thermal plants, cement factories, industries that produce harmful gases, etc.), studies have led to the construction of high chimneys in an attempt to widely disperse the gases and different particles. This dispersion is encouraged by a high emission speed, and it is not uncommon for smoke in full flow to leave a chimney at over 30 m/sec.

Since 1950, reinforced concrete has been widely used to build tall chimneys, which has meant that masonry brickwork with narrow joins is no longer used. Bricks are highly valued, particularly for their resistance to acid smoke and the harmful effects of high temperatures, but when a chimney reaches a height of 70 meters or more it must be resistant to compression forces and the effects of the wind. This means chimney walls must be very thick and deep, large foundations are required, and all this is more costly.

In modern thermal plants, the power of evaporator groups means smoke must be emitted at a great height, and for this reason reinforced concrete is used. It has become much easier to use this material as progress has been made regarding scaffolding and planking methods. Cements that are extremely resistant to acid smoke and the effects of high temperatures have been made, and calculation methods adapted to this type of construction have also been devised.

Reinforced concrete chimneys can be cylindrical or slightly conical in shape, and may have a slight outward inclination (about 2%), which is sometimes greater nearer the base.

Foundations, which are a circular ring in shape, must be resistant against being overturned by strong winds. The chimney section can be circular or polygonal in shape, depending on the planking system used.

Chimneys measuring 150 m in height must be at least 15 cm thick at the highest part with a base of around 30 cm. Chimneys measuring 200 m in height must have a base thickness of 40 cm.

Devices are fitted at the chimney base for the retention of soot, and the concrete must be reinforced with an excess of iron in order to support the excess of weight. The inside is usually formed by a protection that must take into account the two essential factors of degradation:

first, high temperatures that oscillate between 140 C when functioning normally and 200 C if there is an accident; and

second, the sulphurous fumes emitted by most combustion products (carbon powder, mazut, lignite, etc.), which produce sulphuric acid.

Protection must be perfectly guaranteed by a small wall that is packed solid with cement mortar, and extremely resistant to chemicals and high temperatures.

The aforementioned protection wall is made up of 11 cm thick anti-acid refractory bricks, and is built alongside the chimney. It stands on circular concrete units inside the chimney, and a 10 cm gap is left between this wall and the outside face of the chimney.

The mortar sand used for these walls must be silica or quartz sand, and the mortar must be treated at the same time as an air conductor and water repellent. This is achieved by mixing it with less water than usual, without exceeding the value of 0.5 of the water-cement ratio in weight.

On the other hand, it is extremely important to protect the mortar from drying out too quickly as it hardens, and this is achieved by spraying it with a temporary varnish called “curing compound” (an English term given to products that slow down the hardening process).

The cements that are most resistant to heat and acidic smoke are aluminous cement and metallurgical pozzolan cement. It must be pointed out that the chimneys must be marked with beacons during the night as a warning to planes, and they must also be fitted with lightning conductors.

Metal chimneys can be built for medium-sized industrial installations and those that do not need a dust separator for the gases emitted. They are made of sheet metal with an inside covering that protects the metal from the corrosion caused by the acidic smoke. This covering is made up of a 3-4 cm layer of aluminous cement or metallurgical pozzolan cement applied upon a metal grille or directly onto the wall.

### BRIEF SUMMARY OF THE INVENTION

The device for the rapid consumption of the combustible load found within reach of a fire, in addition to the smoke and hot gases produced by the fire, takes advantage of the air chamber to establish depressions that rapidly consume the combustible load found within reach of the fire, using the chimney effect of natural methods or conventional systems.

More specifically, the aim of the invention is to take advantage of the chimney effect in a double-sheeted façade with a ventilated air chamber, as a conduct through which smoke and gases are emitted in order to help reduce the strength of, and (in some cases) extinguish a fire.

The device for the rapid consumption of the combustible load found within reach of a fire, in addition to the smoke and hot gases it produces, has come about due to the fact that the current construction of all types of rooms, departments or outbuildings incorporates lights, enclosed balconies, and above all ventilation towards the outside. This ventilation produces a movement of air or air streams and makes hot air expand, lose density, and therefore reduce pressure (while on the contrary cold air contracts and increases pressure).

Cold air lies below hot air and the front is divided into two (a warm front and a cold front), which makes the cold front rise to meet the warm front. An occluded front is formed that seeks contact with the atmosphere through the orifice at the mouth of the chimney.

The first few minutes of a fire are the most important. If fires that could have been put out with a bucket of water, are left to develop without any type of control for approximately 15-30 minutes (the time it takes fire-fighters to reach a fire), the intensity of the fire can become so great that it becomes extremely difficult to put out and it burns out of control.

In short, the fire is not controlled and burns everything in its path.

To sum up, the device described in this report is conceived in such a way that, by taking advantage of diffusion by convection along vertical surfaces, it can control a fire from the very first few minutes, without the need of human help, by resorting to the physical-chemical properties of the elements that make up a fire, helped by determined natural or mechanical mechanisms, and put into action naturally or mechanically.

### BRIEF DESCRIPTION OF THE SEVERAL VIEWS OF THE DRAWINGS

In order to complement this description, and for a better understanding of the characteristics of the invention, a set of illustrative and non-restrictive diagrams is enclosed as an integral part of the description.

FIG. 1 is an elevated side cross-sectional view of the invention that corresponds to a device for the rapid consumption of the combustible load found within reach of a fire, in addition to the smoke and hot gases produced by the fire.

FIG. 2 is a perspective view of an illustration of the wrought iron or fire-resistant reinforced concrete horizontal structure, placed between two floors.

FIG. 3 is a partial sectional view of the object represented in the previous diagrams.

FIG. 4 is a partial sectional view of the outside sheet of the façade with its various elements.

FIG. 5 is a front elevation view of the building where the invention can be incorporated in the front and back façade, or even in the perimeter of the building itself.

### DETAILED DESCRIPTION OF THE INVENTION

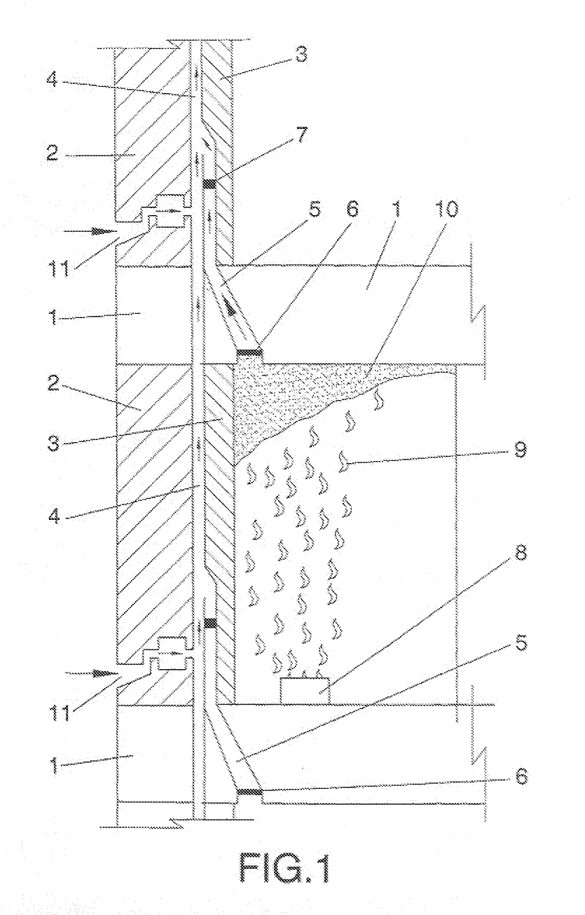

FIG. 1 shows how the device for the rapid consumption of the combustible load found within reach of a fire, in addition to the smoke and hot gases produced by the fire, is made up of wrought iron (1) or a fire-resistant reinforced concrete horizontal structure, placed between the floors. It incorporates an outside sheet (2) made of reinforced concrete, ceramic material or any other fire-resistant material that fulfils the specific requirements, in addition to an inside sheet (3) of the façade of identical characteristics. There is also an air chamber (4), which is applied as a chimney or depression chamber, where the evacuation of smoke and gases begins.

FIG. 1 also shows the entrance to the conduct (6), shaped like a chimney (5) or depression chamber, an exit (7) with the central shaft or flue of the chimney (5), a point (8) or place where the fire begins, and a plume of smoke (9) or accumulation of smoke and hot gases that rises towards the ceiling, where the layer of smoke and hot gases (10) accumulates. It also shows the entrance of air (11) from the outside.

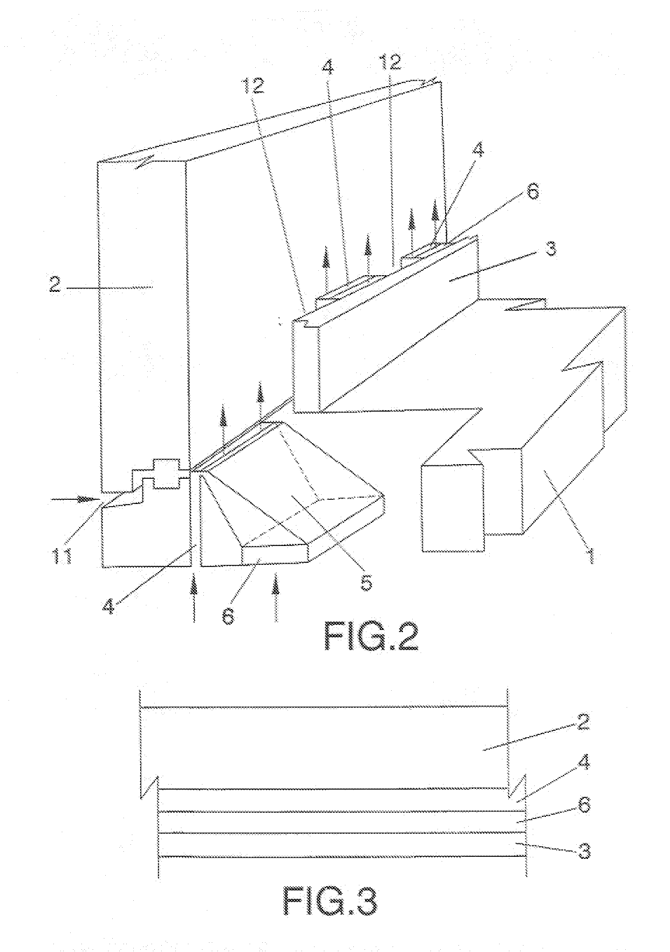

FIG. 2 again shows the wrought iron (1) or fire-resistant reinforced concrete horizontal structure, placed between the floors, in addition to the outside sheet (2) and inside sheet (3) of the façade, incorporating the ventilated air chamber (4) and the flue or shaft (5) for the evacuation of smoke and hot gases. It also shows the entrance of air (11) from the outside and the independent chamber (12), which is not joined in any way to the chimney (5).

In FIG. 3, the outside sheet (2) and inside sheet (3) of the façade can be seen, in addition to the ventilated air chamber (4).

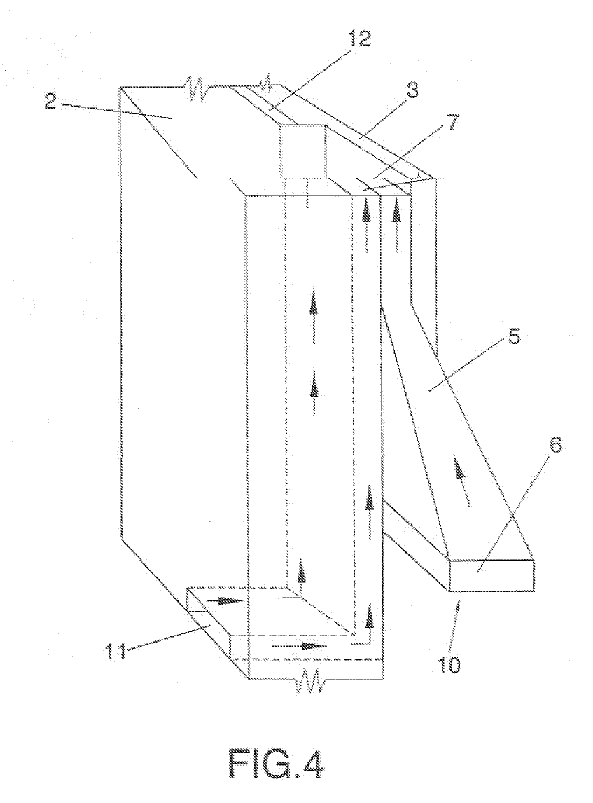

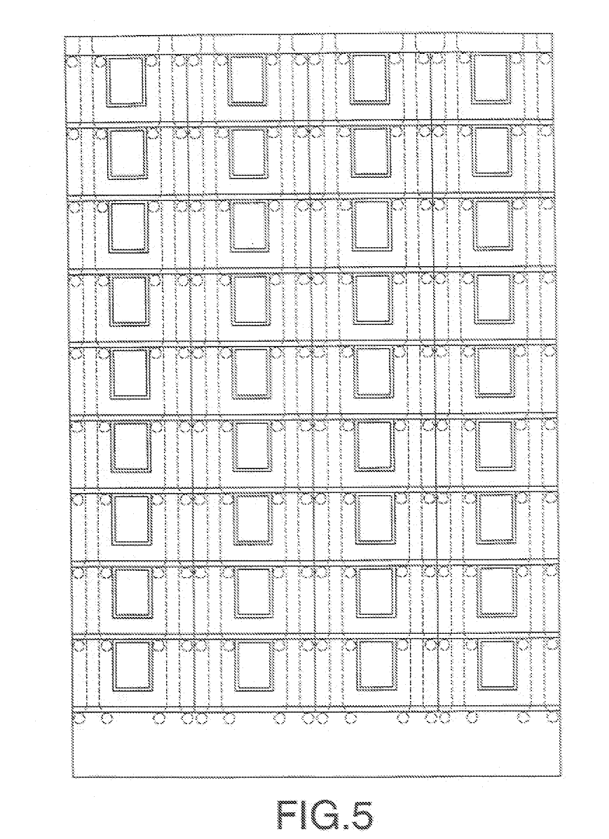

FIG. 4 shows the outside sheet (2) and inside sheet (3) of the façade, the air chamber (4) connected to the central flue or shaft (7) of the chimney (5), while the independent air chamber (12) and chimney (5) are shown as in FIG. 2.

FIG. 4 also shows the entrance (6) to the conduct of the chimney (5), where the smoke and gases accumulate before being evacuated along the chimney.

The same diagram shows the exit (7) or union with the central flue or shaft of the chimney (5), in addition to the entrance of air (11) from the outside.

In short, FIG. 1 shows how the double-sheeted façade (2) and (3) [corresponding to the outside and inside sheet, respectively] with the air chamber (4) built in reinforced concrete (which is resistant to fire for a determined period of time), is shaped in such a way that it takes advantage of the ventilated air chamber with a chimney (5), in the case of an accidental fire, with differences in pressure, in an aim to let smoke and gases escape, and avoid explosions that may be produced due to a lack of oxygen.

In accordance with the aforementioned explanation, when there is a fire in a room, a plume of smoke (9) and hot gases forms and rises towards the ceiling. As the fire burns more intensely, the layer of smoke and hot gases (10) gets thicker and accumulates at the ceiling, trying to find a way out through a crack in a door or window.

As there is no way out, the smoke and hot gases (10) invade the adjoining room, creating air streams that circulate in a converging direction (backdraft), which tend to return to the source of the fire looking for higher pressure areas.

While the fire continues to grow in the compartment with a corresponding increase in the thickness and temperature of the gas layer (10) in the upper part, there is a transition of a fire dominated by the materials that first set fire, to a fire dominated by the materials burning in the rest of the room. This transition is known as “flashover” or Generalized Sudden Combustion (C.S.G), and takes the form of explosions caused by a lack of oxygen. These explosions are greatly feared by fire-fighters. According to statistics, this is the most lethal aspect of a fire, which kills the largest number of fire-fighters. Ventilation during the “flashover” is controlled by the size of openings in the room as well as the position of the layer of gas (10) as regards these openings. It must be pointed out that as the layer (10) loses height, the effective ventilation area of the opening becomes smaller.

The conditions that trigger the transition to the “flashover” are reached when the upper part of the layer of smoke and gases (10) reaches approximately 600 deg. C, and the radiant flow of the materials in the room that have not yet set alight is approximately 20 kW/m2.

The active participation of the whole room is characterized by the production of an excess of combustible vapors that cannot be consumed within the room with the combustible air available. This results in the flames spreading through the openings with an air stream from adjacent rooms, or along the outside of the windows if they break. Generally speaking, windows break shortly before or after the “flashover” conditions are reached, to provide an additional ventilated area.

The “flashover” is not the inevitable result of a fire in a compartment, since if the amount of combustibles is limited or if there is a sufficiently big ventilation opening, the layer (10) at the ceiling cannot develop properly to produce the transition to the “flashover” and the active participation of the whole room.

The use of either automatic or manual suppression agents can also interrupt the process during or prior to the “flashover”. It must be pointed out that some research has determined that the heat index of some objects when burning (such as mattresses) can be increased by one or two factors of the fire in a room during the “post-flashover” period.

While the fire continues to grow in the compartment with the corresponding increase in the thickness and temperature of the upper layers of smoke and gases (10), there is a transition of the fire dominated by the materials that first set fire, to a fire dominated by the materials burning in the rest of the room, and this transition is known as “flashover”.

In short, specific circumstances result in a “flashover”, which are listed below:

The layer formed at the ceiling must reach a temperature of 600° C.;

The radiant flow of the materials that have not burned must be approximately 20 kW/m2, combustible must be limited; and

There must be no type of ventilation for the upper layer where the smoke and hot gases accumulate.

Consequently, and according to the invention proposed, these circumstances can be prevented, as cooling and ventilation prevent a “flashover” and the resulting fire. For this objective, it is sufficient to build the entrance (6) of the chimney (5) in a combustible material that ignites at a temperature of between approximately 100° C. and 150° C., leaving the way clear for the smoke and gases to be evacuated. This operation can be carried out naturally or mechanically with ventilators, electro-valves, thermostats or other similar mechanisms.

Finally, it must be added that the combustible load can be reduced by dampening the burning articles in a room using conventional means with water (with or without additives), and therefore the fire can be put out.

The invention can be incorporated in either the front or back façade, the wells of a building, or even the perimeter of the building. A more effective result of the invention is obtained according to whether it is incorporated in the façades, walls or faces that surround the perimeter of the building.

I claim:

1. A device for rapid consumption of a combustible load found within reach of a fire and smoke and hot gases produced by said fire, taking advantage of an air chamber to establish depressions rapidly consuming said combustible load found within reach of said fire, using a chimney effect of natural methods or conventional systems, the device comprising:
an outside façade sheet of reinforced concrete, ceramic material or any other fire-resistant material;
an inside façade sheet of reinforced concrete, ceramic material or any other fire-resistant material;
an air chamber between said outside façade sheet and said inside façade sheet; and
a chimney or depression chamber, connected to said air chamber and having an entrance connected to a conduct and the air chamber, wherein said chimney has an exit or union with the air chamber connected to said chimney, said chimney having a mouth with an entrance from an outside found on said outside façade sheet in agreement with each floor separated by wrought iron.

2. A device for the rapid consumption of the combustible load found within reach of a fire, in addition to the smoke and hot gases produced by the fire, according to claim 1, further comprising:
an independent air chamber.

3. A device for the rapid consumption of the combustible load found within reach of a fire, in addition to the smoke and hot gases produced by the fire, according to claim 1, being incorporated in either a front façade, back façade, on sides, and in wells of a building, surrounding a perimeter of said building to be protected.
